(19) United States
(12) Patent Application Publication
(10) Pub. No.: US 2020/0003597 A1
(43) Pub. Date: Jan. 2, 2020

(54) AIR FLOW MEASURING DEVICE

(71) Applicant: DENSO CORPORATION, Kariya-city (JP)

(72) Inventors: Teruaki KAIFU, Kariya-city (JP); Noboru KITAHARA, Kariya-city (JP); Kengo ITO, Kariya-city (JP)

(21) Appl. No.: 16/564,017

(22) Filed: Sep. 9, 2019

Related U.S. Application Data
(63) Continuation of application No. PCT/JP2018/009851, filed on Mar. 14, 2018.

(30) Foreign Application Priority Data
Apr. 14, 2017 (JP) 2017-080777

(51) Int. Cl. G01F 1/696; F02D 41/18; G01F 1/72; F02D 45/00

(52) U.S. Cl. CPC G01F 1/6965; F02D 45/00; G01F 1/72; F02D 41/187

(57) ABSTRACT

An air flow rate measuring device measures an air flow rate based on an output value of a sensing unit placed in an environment that allows air to flow therethrough. The air flow rate measuring device includes: an acquisition unit configured to acquire the output value; a storage unit configured to store uneven flow information that indicates an uneven flow state of the air in the environment; a pulsation error correction unit configured to correct the air flow rate by using at least one of the uneven flow information and the output value such that the pulsation error Err in the air flow rate caused by the uneven flow becomes smaller.

### CROSS REFERENCE TO RELATED APPLICATION

The present application is a continuation application of International Patent Application No. PCT/JP2018/009851 filed on Mar. 14, 2018, which designated the U.S. and claims the benefit of priority from Japanese Patent Application No. 2017-80777 filed on Apr. 14, 2017. The entire disclosures of all of the above applications are incorporated herein by reference.

### TECHNICAL FIELD

The present disclosure relates to an air flow measurement device.

### BACKGROUND ART

Conventionally, an air flow measurement device is provided to an internal combustion engine to measure a flow rate of intake air. Intake air drawn into an internal combustion engine may arise pulsation.

### SUMMARY OF INVENTION

According to one aspect of the present disclosure, an air flow measuring device is configured to measure an air flow based on an output value of a sensing unit installed in an environment that allows air to flow therethrough. An acquisition unit is configured to acquire the output value of the sensing unit.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a schematic configuration of a system including an AFM according to a first embodiment of the present disclosure;

FIG. 2 is a block diagram showing a schematic configuration of a processing unit according to the first embodiment;

FIG. 3 is a conceptual diagram showing an installation environment of the AFM according to the first embodiment;

FIG. 4 is a conceptual diagram showing a relationship between the AFM and an air cleaner according to the first embodiment;

FIG. 5 is a block diagram showing a schematic configuration of a processing unit according to a second embodiment of the present disclosure;

FIG. 6 is a conceptual diagram showing an AFM mounted on an air cleaner, according to the second embodiment;

FIG. 7 is a block diagram showing a schematic configuration of a processing unit according to a third embodiment of the present disclosure;

FIG. 8 is a graph showing a relationship between an uneven flow degree and a pulsation error according to the third embodiment;

FIG. 9 is a explanatory graph showing the uneven flow degree according to the third embodiment;

FIG. 10 is a view showing a relationship between a shape of the air cleaner and an average flow velocity distribution according to the third embodiment;

FIG. 11 is a block diagram showing a schematic configuration of a processing unit according to a fourth embodiment of the present disclosure;

FIG. 12 is a view showing a two-dimensional map according to a modified example of the fourth embodiment;

FIG. 13 is a block diagram showing a schematic configuration of a processing unit according to a fifth embodiment of the present disclosure;

FIG. 14 is a block diagram showing a schematic configuration of a processing unit according to a sixth embodiment of the present disclosure;

FIG. 15 is a block diagram showing a schematic configuration of a processing unit according to a seventh embodiment of the present disclosure;

FIG. 16 is a block diagram showing a schematic configuration of a processing unit according to a eighth embodiment of the present disclosure;

FIG. 17 is a block diagram showing a schematic configuration of a processing unit according to a ninth embodiment of the present disclosure;

FIG. 18 is a view showing a two-dimensional map according to a modified example 1 of the ninth embodiment;

FIG. 19 is a graph showing multiple relationships between pulsation amplitudes and pulsation errors, respectively, according to the first modification of the ninth embodiment;

FIG. 20 is a view showing a two-dimensional map according to a second modification of the ninth embodiment;

FIG. 21 is a block diagram showing a schematic configuration of a processing unit according to a tenth embodiment of the present disclosure; and

FIG. 22 is a block diagram showing a schematic configuration of a system including an AFM according to an eleventh embodiment of the present disclosure.

### DESCRIPTION OF EMBODIMENTS

To begin with, one example of an air flow measurement device and a control device for an internal combustion engine according to the present disclosure will be described. The control device calculates a pulsation amplitude ratio and a pulsation frequency. The control device further calculates a pulsation error from the pulsation amplitude ratio and the pulsation frequency. Furthermore, the control device refers to a pulsation error correction map to acquire a correction coefficient for correcting the pulsation error from the pulsation amplitude ratio and the pulsation frequency. The control device further calculates an air quantity in which the pulsation error has been corrected.

Presumably, a pulsation error may arise due to an uneven flow caused in an environment where the air flow sensor is installed. In this situation, the control device may not adapt to a change in the pulsation error caused by the uneven flow. Consequently, the control device may become exacerbated in correction accuracy.

According to one example of the present disclosure, an air flow measuring device is configured to measure an air flow based on an output value of a sensing unit installed in an environment that allows air to flow therethrough. The air flow measuring device comprises: an acquisition unit configured to acquire an output value; a storage unit configured to store uneven flow information that indicates an uneven flow state of an air flow in the environment; and a pulsation error correction unit configured to correct an air flow rate by using at least one item of the uneven flow information and the output value such that the pulsation error in the air flow rate caused by the uneven flow becomes smaller.

As described above, this one example includes the uneven flow information that indicates the uneven flow state of the air flow in the environment where the sensing unit is placed. In addition, this one example is configured to correct the air flow rate by using at least one item of the uneven flow information and the output value such that the pulsation error in the air flow rate caused by the uneven flow becomes smaller. Therefore, the air flow rate can be corrected according to a change in the pulsation error caused by the uneven flow. Therefore, this one example enables to enhance the correction accuracy of the air flow rate. In addition, this one example enables to enhance the correction accuracy and therefore enables to reduce the pulsation error in the air flow rate.

As follows, multiple embodiments for implementing the present disclosure will be described with reference to the drawings. In each embodiment, portions corresponding to those described in the preceding embodiment are denoted by the same reference numerals, and redundant descriptions will be omitted in some cases. In each embodiment, in a case where only a part of the configuration is described, the other part of the configuration may be applied with reference to the other embodiment described above.

### First Embodiment

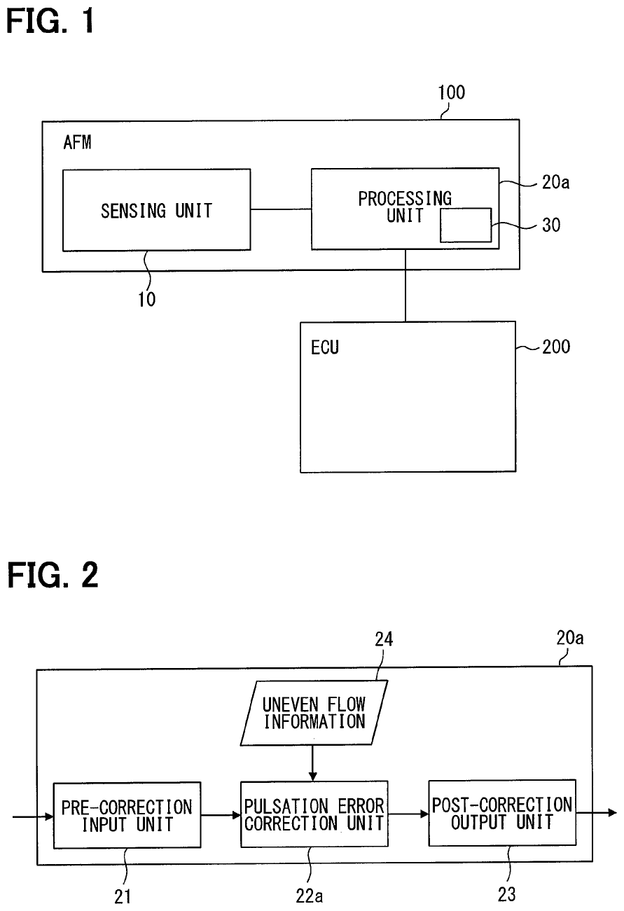

An air flow measurement device of a first embodiment will be described with reference to FIGS. 1 to 4. As shown in FIG. 1, the present embodiment employs an example in which the air flow rate measuring device is applied to an AFM (air flow meter) 100. That is, the AFM 100 corresponds to the air flow rate measurement device.

The AFM 100 is mounted on a vehicle provided with, for example, an internal combustion engine (hereinafter referred to as an engine). Further, the AFM 100 has a thermal type air flow rate measurement function to measure the flow rate of intake air to be drawn into a cylinder of the engine. That is, the present embodiment employs the AFM 100 that measures, as the air flow rate, the intake flow rate, which is the flow rate of intake air. Therefore, the air flow rate may also be referred to as the intake air flow rate. However, this is merely an example of the air flow measurement device. In other words, the AFM 100 is a hot wire-type air flow meter.

As shown in FIG. 1, the AFM 100 mainly includes a sensing unit 10 and a processing unit 20a. Further, the AFM 100 is electrically connected to an ECU (electronic control unit) 200. The ECU 200 is an engine control device having a function to control the engine based on a detection signal from the AFM 100 or the like. This detection signal is an electric signal indicating an air flow rate, which is corrected by using a pulsation error correction unit 22a.

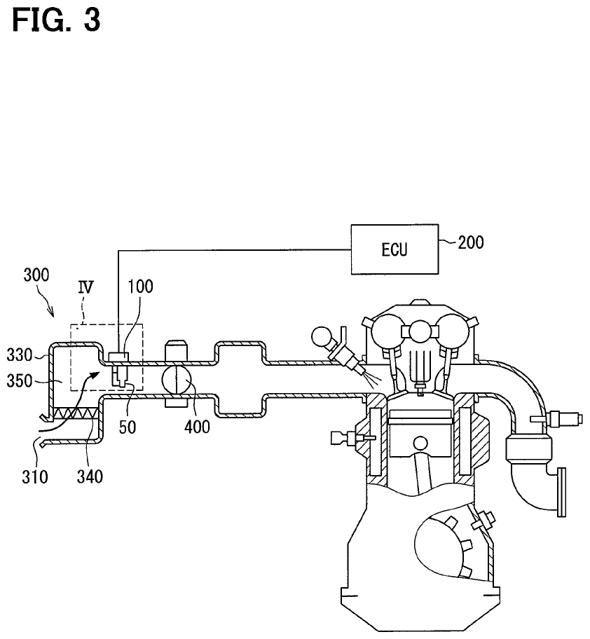

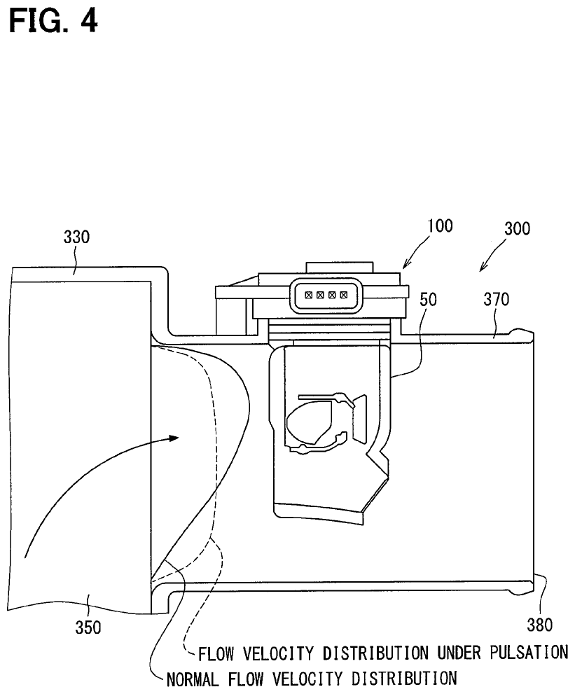

The AFM 100 measures the air flow rate based on an output value from the sensing unit 10, which is placed in an environment where air flows, while performing pulsation correction or the like by using the processing unit 20a. As shown in FIGS. 3 and 4, in the present embodiment, the AFM 100 mounted to an air cleaner 300 is employed as an example. Therefore, the air cleaner 300 may also be paraphrased by a mounted object. It is noted that, the object on which the AFM 100 is mounted is not limited to the air cleaner 300. As shown in FIGS. 3 and 4, in the air cleaner 300, intake air flows in a direction indicated by the bold arrow in a condition where intake air does not flow in reverse.

Air cleaner 300 is configured to purify intake air drawn into the engine. The air cleaner 300 includes an element 340 for filtering intake air and a cleaner case 330 accommodating the element 340. Further, the air cleaner 300 has an intake inlet 310 as an intake port to the cleaner case 330 and an outlet duct 370 through which intake air having passed through the element 340 flows. Further, the air cleaner 300 has an intake outlet 380 which is an end of the outlet duct 370 and is an outlet of the intake air that has passed through the element 340.

The element 340 is configured with a filter material, such as a nonwoven fabric of synthetic fibers or a filter paper. The element 340 is placed between the intake inlet 310 and the intake outlet 380 in the cleaner case 330. The configuration causes the intake air, which has entered through the intake inlet 310, to pass through the element 340 and further to move toward the intake outlet 380.

The reference numeral 350 in FIGS. 3 and 4 represents a clean side space 350, which is a part of a space surrounded by the cleaner case 330 and is placed between the element 340 and the outlet duct 370. In the configuration, the clean side space 350 causes the intake air, which has been filtered through the element 340, to flow therethrough.

An intake inlet 310 is provided with an upstream intake pipe which forms an intake passage on the upstream side of the air cleaner 300. On the other hand, the intake outlet 380 is provided with a downstream side intake pipe which forms an intake passage on the downstream side of the air cleaner 300.

As shown in FIG. 3, a throttle valve 400 is provided to the downstream side intake pipe. In other words, the throttle valve 400 is provided to the downstream side of the air cleaner 300 in the intake passage. The upstream represents an upstream of the sensing unit 10 in a condition where the intake air does not flow in reverse. On the other hand, the downstream represents a downstream of the sensing unit 10 in a condition where the intake air does not flow in reverse.

In the air cleaner 300, for example, a rectifying grid may be provided between the element 340 and the sensing unit 10 to rectify the intake air. Presumably, the intake air, which has passed through the element 340, is disturbed in flow due to the internal shape of the cleaner case 330 or the like. In consideration of that, a rectifying grid provided to rectify the intake air on the upstream side of the sensing unit 10 enables to stabilize the property of the AFM 100.

The sensing unit 10 is placed in an air flowing environment such as an intake duct which forms an intake passage. The intake duct includes, for example, the outlet duct 370, a downstream intake pipe, or the like. That is, the AFM 100 measures a partial flow velocity of air such as air in the center of the intake duct. In other words, the AFM 100 is a local flow meter. The present description employs, as an example, a configuration in which the AFM 100 is placed in the outlet duct 370. It is noted that, another configuration may be employed in which the sensing unit 10 is placed in an environment where air flows.

For example, as disclosed in FIGS. 3 and 4, the sensing unit 10 is placed in the intake duct in a state where being attached to a passage forming member 50. That is, the sensing unit 10 is installed in the passage forming member thereby to be placed in the sub-bypass passage. The passage forming member is formed with a bypass passage (sub-air passage) and a sub bypass passage (auxiliary sub-air passage) through which a part of intake air, which flows through the interior (main air passage) of the intake duct, passes. It is noted that, the present disclosure is not limited to this, and the sensing unit 10 may be placed directly in the main air passage.

The sensing unit 10 includes a heating resistor, a resistance temperature detector, and the like. The sensing unit 10 outputs a sensor signal (output value, output flow rate), which corresponds to a flow rate of air flowing through a sub-bypass flow path, to the processing unit 20a. In other words, the sensing unit 10 outputs the output value, which is an electric signal corresponding to the flow rate of air flowing through the sub-bypass flow path, to the processing unit 20a.

Meanwhile, in the intake duct, intake pulsation including reverse flow occurs due to reciprocating motion of the piston in the engine or the like. In the sensing unit 10, an error may arise in the output value with respect to a true air flow rate due to influence of the intake pulsation. In particular, when the throttle valve 400 is manipulated to the fully open position, the sensing unit 10 is more likely to be affected by the intake pulsation. Furthermore, the intake pulsation is not necessarily a sine wave, and the tendency of error caused in the intake pulsation changes also by deformation of its waveform (including higher order components). Hereinafter, the error caused by the intake pulsation is also referred to as a pulsation error Err. The true air flow rate is an air flow rate which is not affected by the intake pulsation.

uneven flow may occur in dependence upon the shape of its environment where the sensing portion 10 is arranged, such as the shape of the air cleaner 300, that is, the shape of the portion of the intake duct where the intake air contacts. In other words, the uneven flow is caused due to the flow of intake air in the intake system on the upstream side of the environment, in which the sensing unit 10 is mounted, or the flow in the intake system on the upstream side and the intake system on the downstream side of the environment. In other words, the uneven flow is caused due to the flow of intake air in the intake system on the upstream side of the environment, in which the sensing unit 10 is mounted, or the flow in the intake system on the upstream side and the intake system on the downstream side. As shown in FIG. 4, the AFM 100 is exerted with an influence when measuring the air flow rate in a case where a deviation arises in a flow velocity distribution, since, for example, the flow velocity distribution is flattened under a pulsation condition. The uneven flow state differs depending on the shape of the environment, in which the sensing unit 10 is provided, that is, the shape of a portion of the intake duct which the intake air is in contact with.

The upstream intake system is a member that forms the intake passage, in which the sensing unit 10 is mounted, or an intake passage upstream of the sensing unit 10. Therefore, the upstream intake system includes the air cleaner 300 and the like. On the other hand, the downstream side intake system is a member that forms an intake passage downstream of the sensing unit 10. Therefore, the downstream intake system includes a downstream intake pipe and the like.

The processing unit 20a performs a pulsation correction to reduce a pulsation error Err caused by the uneven flow. In other words, the processing unit 20a corrects the pulsation error characteristic caused by the even flow by using the uneven flow information 24 relevant to the even flow state. The even flow is a deviation of a flow of intake air. The uneven flow state is, for example, the uneven flow degree, an uneven flow direction, and the like. In other words, the even flow state can be reworded as an even flow aspect.

The processing unit 20a measures the air flow rate based on the output value of the sensing unit 10 and outputs the measured air flow rate to the ECU 200. The processing unit 20a includes at least one arithmetic processing unit (CPU) and a storage device 30 for storing a program and data. For example, the processing unit 20a is embodied with a microcomputer including the storage device 30 readable by a computer. In the processing unit 20a, the arithmetic processing unit executes various programs stored in the storage medium and performs various computations thereby to measure the air flow rate. The processing unit 20a outputs the measured air flow rate to the ECU 200.

The storage device 30 is a non-transitory tangible storage medium for non-transitory storage of computer readable programs and data. The storage medium is embodied with a semiconductor memory, a magnetic disk, or the like. The storage device 30 may also be referred to as a storage medium. The processing unit 20a may include a volatile memory for temporarily storing data.

The processing unit 20a operates as multiple functional blocks by executing the program. In other words, the processing unit 20a includes multiple functional blocks. As shown in FIG. 2, the processing unit 20a includes, as the multiple functional blocks, a pre-correction input unit 21, the pulsation error correction unit 22a, and a post-correction output unit 23.

The processing unit 20a has a function of correcting the output value in which the pulsation error Err occurs. In other words, the processing unit 20a corrects the air flow rate, in which the pulsation error Err has occurred, to be close to the true air flow rate. The processing unit 20a outputs, as the detection signal, the air flow rate, which is acquired by correcting the pulsation error Err, to the ECU 200.

Furthermore, the processing unit 20a includes uneven flow information 24 used for correction in the pulsation error correction unit 22a. The uneven flow information 24 is stored in the storage device 30. The storage device 30 corresponds to a storage unit. The uneven flow information 24 is information indicating the uneven flow state of air in an environment in which the sensing unit 10 is placed. The uneven flow information 24 may also be referred to as information that indicates an unevenness of air that affects the pulsation error in the environment in which the sensing unit 10 is placed. The uneven flow information 24 is information indicating the uneven flow state of air in, for example, the air cleaner 300. Therefore, the uneven flow information 24 has a different value depending on the environment in which the sensing unit 10 is placed, for example, the environment in which the air cleaner 300 is placed.

The pre-correction input unit 21 corresponds to an acquisition unit and acquires an output value of the sensing unit 10. The pre-correction input unit 21 performs, for example, A/D conversion on the output value, which is output from the sensing unit 10, and samples the A/D converted output value. The pre-correction input unit 21 further converts the output value into the air flow rate with reference to an output air flow rate conversion table. In other words, the pre-correction input unit 21 converts each sampling value into the air flow rate.

The output air flow rate conversion table is a table for converting the output value into the air flow rate. The air flow rate, which is converted with reference to the output air flow rate conversion table, is a value correlating to the output value. This air flow rate may be regarded as the output value used in the pulsation error correction unit 22a.

It should be noted that the pre-correction input unit 21 may calculate an average value, which is acquired by averaging sampling values in one cycle, that is, may calculate an average air flow rate. In this case, the pulsation error correction unit 22a may perform the correction of the air flow rate by correcting the average air flow rate as the output value. The average air flow rate may also be referred to as an average flow rate.

The pulsation error correction unit 22a corrects the air flow rate by using at least one of the uneven flow information 24 and the output value so as to reduce the pulsation error Err in the air flow rate caused by the uneven flow. Herein, an example, which is to correct the air flow rate by using the output value and one of the uneven flow information 24, is employed. For example, the pulsation error correction unit 22a acquires the correction amount Q correlated with the uneven flow information 24 with reference to the map or from the correction function by using the uneven flow information 24. Subsequently, the pulsation error correction unit 22a corrects the air flow rate by using the acquired correction amount Q and the output value. The correction amount Q is a value that enables to reduce the pulsation error Err. In other words, the pulsation error correction unit 22a estimates the correction amount Q.

When the correction amount Q is −Q1, the pulsation error correction unit 22a adds −Q1 to the air flow rate, which has been converted by using the pre-correction input unit 21. That is, the pulsation error correction unit 22a subtracts Q1 from the air flow rate thereby to acquire a post-correction air flow rate which is reduced by the pulsation error Err. When the correction amount Q is +Q2, the pulsation error correction unit 22a adds Q2 to the air flow rate thereby to acquire the corrected air flow rate, which is reduced by the pulsation error Err. It is noted that, the present disclosure is not limited to the above example and may employ another configuration to correct the air flow rate to reduce the pulsation error Err.

In a case where acquiring the correction amount Q with reference to a map, the AFM 100 includes a map, which enables to acquire the correction amount Q with the uneven flow information 24. As a map for acquiring the correction amount Q, for example, a map in which the uneven flow information 24 and the correction amount Q are associated with each other, may be employable. In other words, the map associates multiple items of the uneven flow information 24 and multiple correction amounts Q which are correlated with the items of the uneven flow information 24, respectively.

The map may be created by grasping each item of the uneven flow information 24 and the relationship between the correction amounts Q correlated with items of the uneven flow information 24, respectively, by implementing an experiment or a simulation using a real equipment. In other words, each correction amount Q is a value acquired for each item of the uneven flow information 24 by implementing an experiment or a simulation using a real equipment while changing the value of the uneven flow information 24. In this case, on acquiring the uneven flow information 24, the pulsation error correction unit 22a further acquires the correction amount Q associated with the acquired uneven flow information 24 from the map. It should be noted that, the map in the embodiment to be described below may be similarly created by implementing an experiment or a simulation or the like using an actual equipment.

The post-correction output unit 23 outputs an electrical signal indicating the air flow rate which is corrected by the pulsation error correction unit 22a. That is, the post-correction output unit 23 outputs, to the ECU 200, an electrical signal indicating the air flow rate in which the pulsation error Err is reduced.

As described above, the AFM 100 has the uneven flow information 24 indicating the uneven flow state of air in the environment where the sensing unit 10 is placed. The AFM 100 corrects the air flow rate so as to reduce the pulsation error Err of the air flow rate caused by the uneven flow by using the uneven flow information 24 and the output value of the sensing unit 10, thereby to enable to correct the air flow rate according to change in the pulsation error Err attributable to the uneven flow. In this way, the AFM 100 is enabled to improve the accuracy of correcting the air flow rate. Further, the AFM 100 is enabled to reduce the pulsation error Err of the air flow rate due to the improvement in the correction accuracy. In other words, the AFM 100 is enabled to reduce a pulsation error characteristic attributable to the uneven flow caused in each air cleaner 300.

In general, the state of uneven flow differs depending on a target (in this case, the air cleaner) on which the AFM is mounted. Therefore, the pulsation error Err caused by the uneven flow differs depending on each air cleaner. In general, when the AFM is mounted on an air cleaner, it is conceivable to adapt the pulsation characteristics for each air cleaner, to which the AFM is to be mounted, so that the pulsation error Err becomes smaller.

The AFM 100 enables to reduce the pulsation error characteristic, which is caused by the uneven flow caused in each air cleaner 300. Therefore, the adaptation of the pulsation characteristic implemented for each air cleaner 300 can be reduced. Thus, the AFM 100 enables to reduce the matching of the pulsation characteristics in the hardware required for each air cleaner 300.

As described above, a preferred embodiment of the present disclosure has been described. However, the present disclosure is not limited to the embodiment described above, and various modifications are possible within the scope of the present disclosure without departing from the spirit of the present disclosure. Hereinafter, second to eleventh embodiments will be described as other embodiments of the present disclosure. Each of the above embodiment and the second to eleventh embodiments may be independently implemented, or may be combined appropriately. The present disclosure can be performed by various combinations without being limited to the combination illustrated in the embodiment.

The functions materialized by the processing unit 20a may be materialized by hardware and software different from those described above or by a combination of the hardware and the software. The processing unit 20a may communicate with, for example, another control device, such as an ECU 200, and the other control device may perform some or all of the processing. The processing unit 20a may be implemented by a digital circuit or an analog circuit, including a large number of logic circuits, in a case where the processing unit 20a is materialized by an electronic circuit.

### Second Embodiment

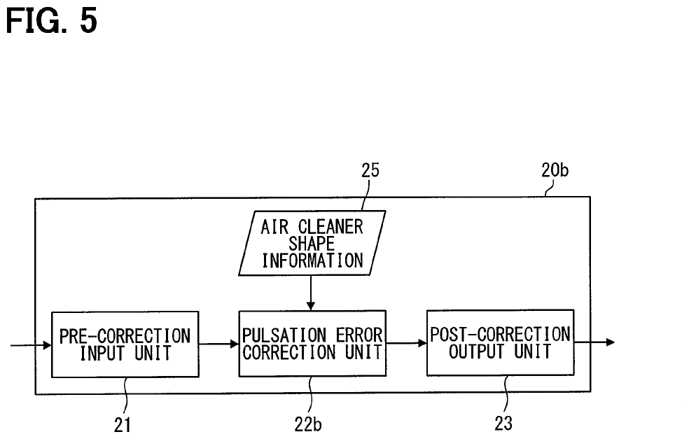

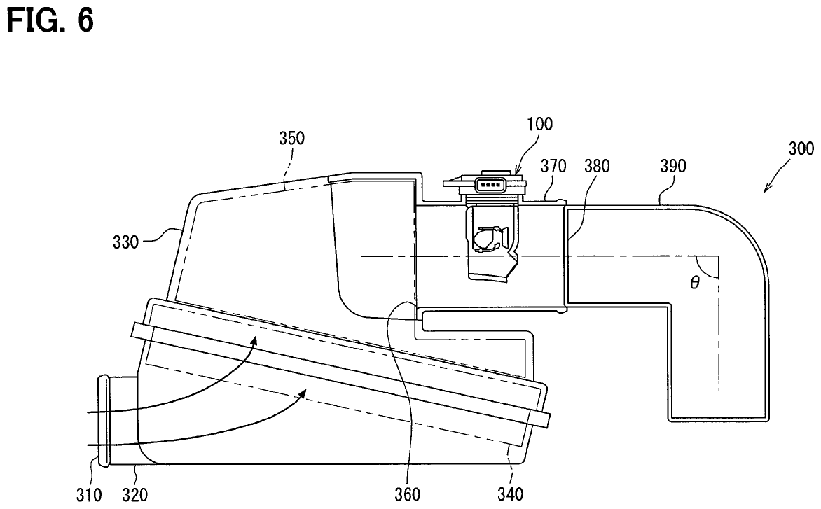

An AFM according to a second embodiment (hereinafter referred to simply as AFM) will be described with reference to FIGS. 5 and 6. In the present embodiment, descriptions of configurations similar to those of the first embodiment will be omitted, and configurations different from those of the first embodiment will be mainly described. That is, the same configurations as those of the first embodiment in the present embodiment can be understood with reference to the description of the first embodiment. Hereinafter, two directions perpendicular to each other are denoted as an X direction and a Y direction.

The AFM differs from the AFM 100 in the configuration of a processing unit 20b. As shown in FIG. 5, the processing unit 20b differs from the processing unit 20a in that the processing unit 20b includes air cleaner shape information 25 and a pulsation error correction unit 22b that corrects the air flow rate by using the air cleaner shape information 25. In other words, the processing unit 20b includes the air cleaner shape information 25 as the uneven flow information 24. The present embodiment also employs an example in which the sensing unit 10 is located in the air cleaner 300. The air cleaner shape information corresponds to shape information.

First, the air cleaner 300 will be described with reference to FIG. 6. As shown in FIG. 6, the air cleaner 300 employed in the present embodiment is different from that of the above embodiment. However, in the present embodiment, for convenience, the same components as those in the above embodiment are denoted with the same reference numerals, respectively, as the above embodiment. As shown in FIG. 6, in the air cleaner 300, intake air flows in a direction indicated by the bold arrow in a condition where intake air does not flow in reverse. Reference numeral 360 in FIG. 6 denotes a corner of the outlet duct 370 on the side of the cleaner case 330.

The air cleaner 300 includes an inlet duct 320 between the intake inlet 310 and the cleaner case 330. The inlet duct 320 is different from the outlet duct 370 in its position in the X direction and in the position in the Y direction and is in parallel with the outlet duct 370. The intake inlet 310 and the intake outlet 380 define opening planes respectively orthogonal to the X direction. The intake inlet 310 is at a position different from the intake outlet 380 in the X direction and in the Y direction.

In FIG. 6, a downstream intake pipe 390 attached to the outlet duct 370 is illustrated. The downstream intake pipe 390 is, as an example, a pipe bent at a right angle. That is, the downstream intake pipe 390 includes a portion extending from the outlet duct 370 in the X direction and a portion bent at a right angle relative to the outlet duct 370 and extending in the Y direction.

Θ in FIG. 6 denotes a bending angle of the downstream intake pipe 390. The bending angle θ is an angle formed between an imaginary straight line passing through the center of the outlet duct 370 and an imaginary straight line passing through the center of the bent portion of the downstream intake pipe 390. In the present example, the bending angle θ is 90 degrees.

As described above, an uneven flow may arise in intake air depending on the shape of the environment, in which the sensing unit 10 is placed, such as the air cleaner 300 and the downstream intake pipe 390. The uneven flow state changes depending on this shape. For this reason, the air cleaner shape information 25, which represents the shape of the air cleaner 300, is a parameter correlated to the uneven flow state in other words. Further in other words, the air cleaner shape information 25 represents the shape of the environment, in which the sensing unit 10 is placed, and is correlated to the unevenness of air affecting the pulsation error Err in the environment in which the sensing unit 10 is placed. As described above, the air cleaner shape information 25 is not limited to only the shape of the air cleaner 300 and may also be referred to as environmental shape information.

The processing unit 20b has the air cleaner shape information 25 as the uneven flow information 24. The air cleaner shape information 25 is stored in the storage device 30. The air cleaner shape information 25 may employ, for example, the positional relationship between the intake inlet 310 and the intake outlet 380, the R dimension of the corner portion 360, the volume of the clean side space 350, the bending angle θ, and the like. In the present embodiment, the processing unit 20b having one of the air cleaner shape information 25 is employed. That is, for example, the processing unit 20b may employ, as the air cleaner shape information 25, the volume of the clean side space 350.

The pulsation error correction unit 22b corrects the air flow rate using the air cleaner shape information 25 and the output value so as to reduce the pulsation error Err of the air flow rate caused by the unevenness. Herein, an example in which the air flow rate is corrected using the output value and one item of the air cleaner shape information 25 is employed. For example, the pulsation error correction unit 22b acquires the correction amount Q, which is correlated with the air cleaner shape information 25, with reference to the map or using the correction function using the air cleaner shape information 25. Subsequently, the pulsation error correction unit 22b corrects the air flow rate by using the acquired correction amount Q and the output value.

The present map is the map described in the above embodiment in which the uneven flow information 24 is replaced with the air cleaner shape information 25. In other words, in the map of the present embodiment, multiple items of the air cleaner shape information 25 are associated with the correction amounts Q, which are correlated with the multiple items of the air cleaner shape information 25, respectively.

Thus, the AFM of the second embodiment enables to exhibit a similar effect to that of the AFM 100. Furthermore, the AFM of the second embodiment enables to quantify the uneven flow state caused by the shape of the air cleaner 300.

### Third Embodiment

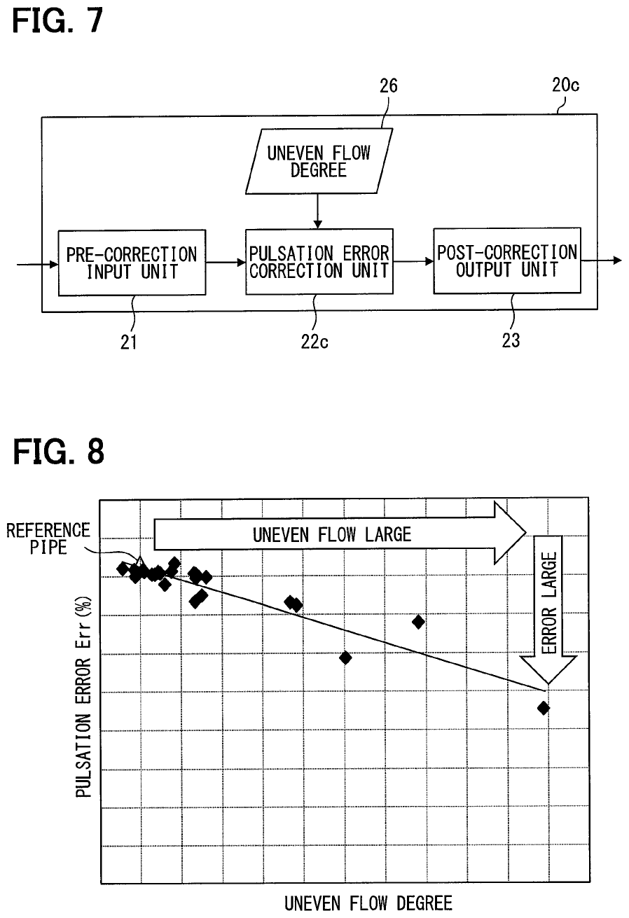

An AFM according to a third embodiment (hereinafter referred to simply as AFM) will be described with reference to FIGS. 7 to 10. In the present embodiment, descriptions of configurations similar to those of the first embodiment will be omitted, and configurations different from those of the first embodiment will be mainly described. That is, the same configurations as those of the first embodiment in the present embodiment can be understood with reference to the description of the first embodiment. Hereinafter, two directions perpendicular to each other are denoted as an X direction and a Y direction.

The AFM differs from the AFM 100 in the configuration of a processing unit 20c. As shown in FIG. 7, the processing unit 20c is different from the processing unit 20a in that the processing unit 20c includes an uneven flow degree 26 and a pulsation error correction unit 22c that corrects the air flow rate using the uneven flow degree 26. In other words, the processing unit 20c includes the uneven flow degree 26 as the uneven flow information 24. The present embodiment also employs an example in which the sensing unit 10 is located in the air cleaner 300.

As shown in FIG. 8, the pulsation error Err changes according to the uneven flow degree 26. The pulsation error Err increases, for example, as the uneven flow degree 26 increases. The uneven flow degree 26 is a parameter obtained by proportioning a relationship between the air flow rate and the output value in the reference pipe 300a, air cleaners 300b and 300c, and the like. It should be noted that there is a correlation between the uneven flow degree 26 and the pulsation error Err found by an actual measurement or a simulation.

Each of triangular marks in FIG. 8 indicates the relationship between the uneven flow degree 26 and the pulsation error Err when the AFM is installed to a reference tube 300a. On the other hand, each of rhombic marks in FIG. 8 indicates the relationship between the uneven flow degree 26 and the pulsation error Err when the AFM is installed to corresponding one of various air cleaners such as the air cleaners 300b and 300c.

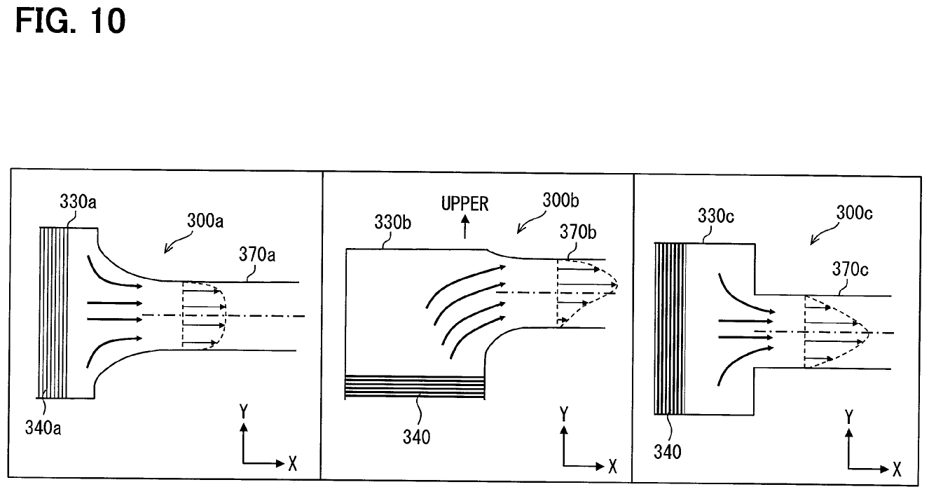

FIG. 10 shows the reference pipe 300a and an example of the air cleaner. The reference pipe 300a is a tube having a predetermined tube diameter through which air flows and can be regarded as a test tube used for inspecting the characteristics of the AFM 100 itself. The reference pipe 300a includes a cleaner case 330a, a rectifying grid 340a, an outlet duct 370a, and the like. Air flows in the direction shown by the bold arrow. The reference pipe 300a is not used as an intake passage of a vehicle in an actual use. Therefore, the reference pipe 300a may not include the element 340.

The reference tube 300a is provided with the rectifying grid 340a and is smoothly connected with the outlet duct 370a to the cleaner case 330a. Therefore, as shown by the broken lines, the reference tube 300a exhibits a flow velocity distribution similar to an average flow velocity distribution. In other words, the reference pipe 300a is a standard pipe 300a.

The first air cleaner 300b includes a cleaner case 330b, the element 340, an outlet duct 370b, and the like. The first air cleaner 300b allows intake air to flow in the direction shown by the bold arrows. The first air cleaner 300b is employed as an intake passage of a vehicle in its actual use. In the first air cleaner 300b, the direction of intake air passing through the element 340 is different from the direction of intake air passing through the outlet duct 370b. In other words, in the first air cleaner 300b, the intake direction is different from a duct axis which is the center axis of the outlet duct 370b. For this reason, in the first air cleaner 300b, the average flow velocity distribution is uneven. Specifically, the average flow velocity distribution deviates upward.

The second air cleaner 300c includes a cleaner case 330c, the element 340, an outlet duct 370c, and the like. The second air cleaner 300c allows intake air to flow in the direction shown by the bold arrows. The second air cleaner 300c is employed as an intake passage of a vehicle in its actual use.

In the second air cleaner 300c, the direction of intake air passing through the element 340 is the same as the direction of intake air passing through the outlet duct 370c. However, in the second air cleaner 300c, the inlet of the outlet duct 370c is at a right angle. That is, in the second air cleaner 300c, a corner portion between the cleaner case 330c and the outlet duct 370c is at a right angle. In other word, in the second air cleaner 300c, the outlet duct 370c has a smaller opening diameter than that of the cleaner case 330c. For this reason, in the air cleaner 300c, the average flow velocity distribution is uneven. Specifically, the average flow velocity distribution deviates to the center of the outlet duct 370c.

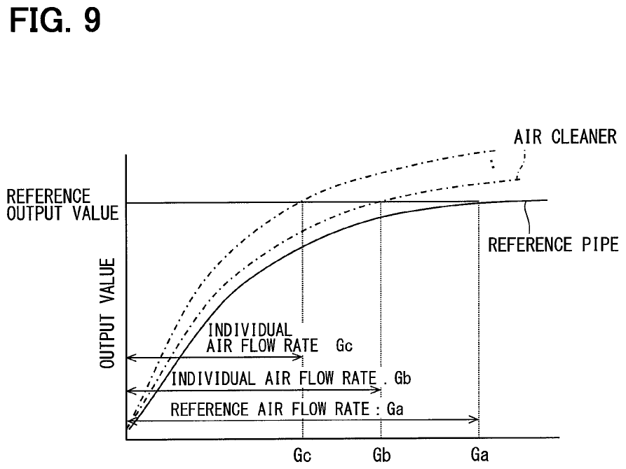

Therefore, as shown in FIG. 9, the relationship between the air flow rate and the output value of the AFM varies among the reference tube 300a and the air cleaners 300b and 300c. The solid line in FIG. 9 shows the relationship between the air flow rate and the output value for the reference pipe 300a. Each of the broken lines in FIG. 9 shows the relationship between the air flow rate and the output value for the air cleaners 300b and 300c.

The uneven flow degree 26 is a value calculated by dividing a reference air flow rate Ga by an individual air flow rate. The reference air flow rate Ga, as a numerator, corresponds to a reference output value when the sensing unit 10 is installed to the reference pipe 300a. The individual air flow rate, as a denominator, corresponds to a reference output value when the sensing unit 10 installed to the air cleaner or the like outputs the reference output value. Therefore, in an air cleaner with the individual air flow rate Gb, the uneven flow degree 26 is: (reference air flow rate Ga/individual air flow rate Gb). Similarly, in an air cleaner with the individual air flow rate Gb, the uneven flow degree 26 is: (reference air flow rate Ga/individual air flow rate Gc).

Thus, the uneven flow degree 26 differs depending on the shape of the environment to which the sensing unit 10 is installed, such as the air cleaner 300 and the downstream intake pipe 390. As described above, an uneven flow may arise in intake air depending on the shape of the environment, to which the sensing unit 10 is installed, such as the air cleaner 300 and the downstream intake pipe 390. The uneven flow state changes depending on this shape. Therefore, in other word, the uneven flow degree 26 is a parameter correlating to the uneven flow state. Further in other words, the uneven flow degree 26 is information correlating to the unevenness of air that affects the pulsation error Err in the environment in which the sensing unit 10 is installed.

Therefore, the processing unit 20c has the uneven flow degree 26 as the uneven flow information 24. The uneven flow degree 26 is stored in the storage device 30. The pulsation error correction unit 22c corrects the air flow rate using the uneven flow degree 26 and the output value so as to reduce the pulsation error Err of the air flow rate caused by the uneven flow.

Herein, an example, which is to correct the air flow rate by using the output value and one uneven flow degree 26, is employed. For example, the pulsation error correction unit 22c acquires a correction amount Q correlated with the uneven flow degree 26 with reference to the map or using the correction function by using the uneven flow degree 26. Subsequently, the pulsation error correction unit 22c corrects the air flow rate by using the acquired correction amount Q and the output value.

The map in this case is the map described in the above embodiment in which the uneven flow information is replaced with the uneven flow degree 26. That is, in other words, in the map of the present embodiment, multiple uneven flow degrees 26 and the correction amounts Q correlated with the uneven flow degrees 26 are associated, respectively.

Thus, the AFM of the third embodiment enables to exhibit a similar effect to that of the AFM 100. Furthermore, the AFM of the third embodiment enables to quantify the uneven flow state caused by the shape of the air cleaner 300.

### Fourth Embodiment

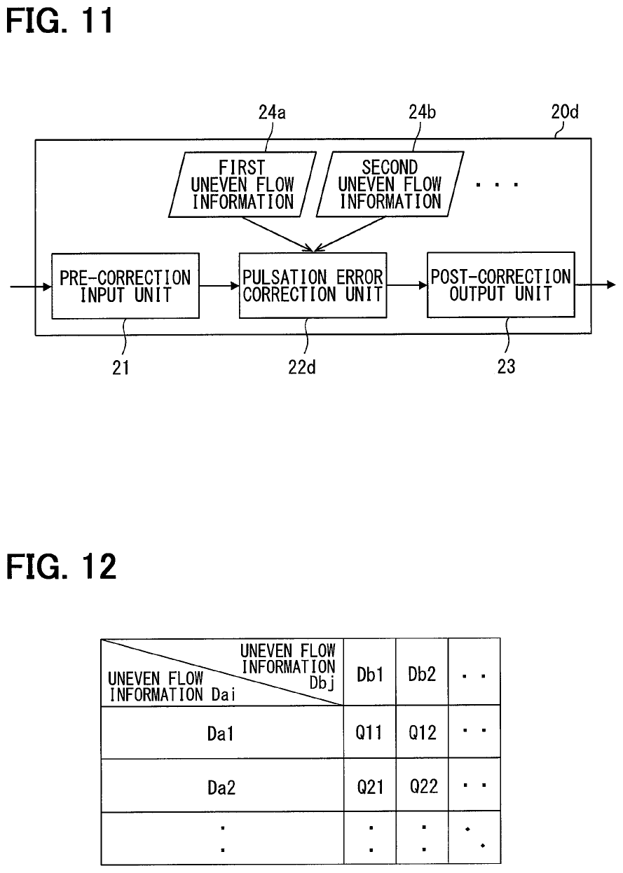

An AFM according to a fourth embodiment (hereinafter referred to simply as AFM) will be described with reference to FIG. 11. In the present embodiment, descriptions of configurations similar to those of the first embodiment will be omitted, and configurations different from those of the first embodiment will be mainly described. That is, the same configurations as those of the first embodiment in the present embodiment can be understood with reference to the description of the first embodiment.

The AFM differs from the AFM 100 in the configuration of a processing unit 20d. As shown in FIG. 11, the processing unit 20d is different from the processing unit 20a in that the processing unit 20d includes a pulsation error correction unit 22d that corrects the air flow rate using multiple items of the uneven flow information 24a and 24b and multiple items of the uneven flow information 24a and 24b. In other words, the processing unit 20d includes multiple items of the uneven flow information 24a and 24b. The present embodiment also employs an example in which the sensing unit 10 is located in the air cleaner 300. In the present embodiment, as an example, the processing unit 20d using two items including the first uneven flow information 24a and the second uneven flow information 24b is employed. It is noted that, the processing unit 20d may include three or more items of the uneven flow information.

The pulsation error correction unit 22d corrects the air flow rate by using the output value and the multiple items of the uneven flow information 24a and 24b so as to reduce the pulsation error Err in the air flow rate caused by the uneven flow. For example, the pulsation error correction unit 22d acquires the correction amounts Q correlated with the multiple items of the uneven flow information 24a and 24b with reference to the map or using the correction function by using the multiple items of the uneven flow information 24a and 24b. Subsequently, the pulsation error correction unit 22d corrects the air flow rate by using the acquired correction amount Q and the output value.

The correction function may be expressed by a polynomial: correction amount Q=α1×D1+α2×D2+α3×D3+ . . . . In this correction function, α1 is a constant, and D1 is the uneven flow information. Therefore, in the present embodiment, the correction amount Q can be acquired by calculating α1×D1+α2×D2. In this case, D1 corresponds to the uneven flow information 24a, and D2 corresponds to the uneven flow information 24b. The constants such as the constants α1, α2, α3 in the correction function may be determined by implementing multiple regression analysis or the like.

In this way, the AFM of the fourth embodiment enables to exhibit a similar effect to that of the AFM 100. Furthermore, the AFM of the fourth embodiment corrects the air flow rate by using the multiple items of the uneven flow information 24a and 24b, thereby to enable to further enhance the correction accuracy of the air flow rate. The AFM of the fourth embodiment therefore enables to further reduce the pulsation error Err in the air flow rate.

### Modification of Fourth Embodiment

Hereinafter, an AFM of a modification of the fourth embodiment (hereinafter referred to simply as AFM) will be described with reference to FIG. 12. In the present modification, descriptions of configurations similar to those of the fourth embodiment will be omitted, and configurations different from those of the fourth embodiment will be mainly described. That is, the same configurations as those of the fourth embodiment in the present modification can be understood with reference to the description of the fourth embodiment.

The AFM differs from that of the fourth embodiment in that the pulsation error correction unit 22d acquires the correction amount Q from the output value and multiple items of the uneven flow information 24a and 24b by using a two-dimensional map. As shown in FIG. 12, in the two-dimensional map, the correction amounts Qij are associated respectively with combinations of the multiple items of the uneven flow information Dai and the multiple items of the uneven flow information Dbj. i and j are natural numbers which are one or more. In other words, each of the correction amounts Qij is a value obtained for the corresponding combination of the uneven flow information Dai and Dbj by implementing an experiment or a simulation using an actual equipment while changing values of the uneven flow information Dai and Dbj.

Therefore, the pulsation error correction unit 22d acquires the correction amounts Qij respectively correlated with the combinations of the multiple items of the uneven flow information Dai and Dbj with reference to the map by using the multiple items of the uneven flow information Dai and Dbj. Subsequently, the pulsation error correction unit 22d corrects the air flow rate by using the acquired correction amount Qij and the output value. For example, in a case where the pulsation error correction unit 22d includes the uneven flow information Da1 and Db1, the pulsation error correction unit 22d acquires the correction amount Q11 and corrects the air flow rate by using the correction amount Q11 and the output value. Similarly, in a case where the pulsation error correction unit 22d includes the uneven flow information Da2 and Db2, the pulsation error correction unit 22d acquires the correction amount Q22 and corrects the air flow rate by using the correction amount Q22 and the output value.

In this way, the AFM of the modification of the fourth embodiment enables to exhibit a similar effect to that of the AFM of the fourth embodiment.

### Fifth Embodiment

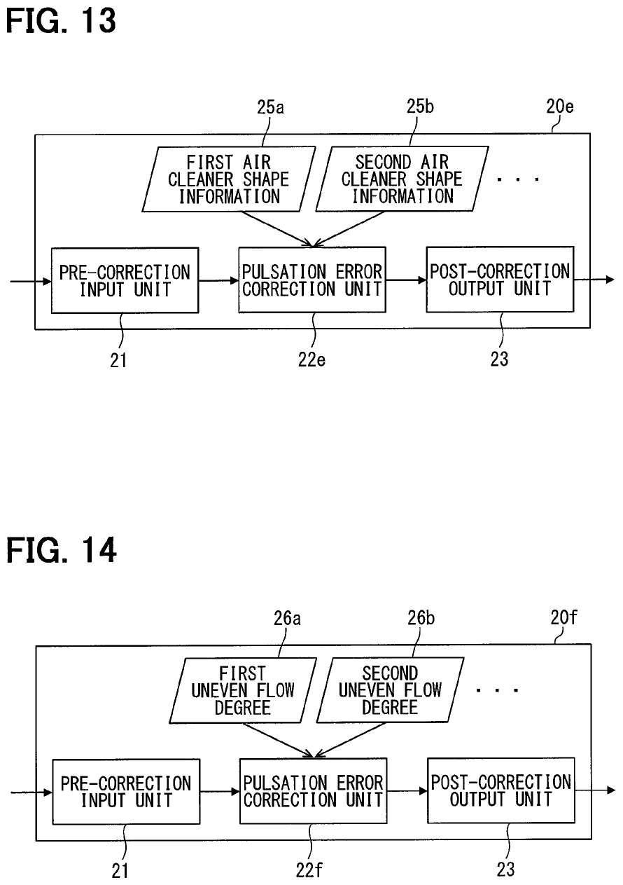

An AFM according to a first embodiment (hereinafter referred to simply as AFM) will be described with reference to FIG. 13. In the present embodiment, descriptions of configurations similar to those of the fourth embodiment will be omitted, and configurations different from those of the fourth embodiment will be mainly described. That is, the same configurations as those of the fourth embodiment in the present modification can be understood with reference to the description of the fourth embodiment.

The AFM differs from the AFM of the fourth embodiment in the configuration of a processing unit 20e. As shown in FIG. 13, the processing unit 20e differs from the processing unit 20d in that the processing unit 20e includes a pulsation error correction unit 22e that corrects the air flow rate by using multiple items of the air cleaner shape information 25a and 25b and multiple items of the air cleaner shape information 25a and 25b. That is, in other words, the processing unit 20e includes the multiple items of the air cleaner shape information 25a and 25b. The present embodiment also employs an example in which the sensing unit 10 is located in the air cleaner 300. In the present embodiment, as an example, the processing unit 20e using two items including the first air cleaner shape information 25a and the second air cleaner shape information 25b is employed. It is noted that, the processing unit 20e may include three or more items of the air cleaner shape information.

The pulsation error correction unit 22e corrects the air flow rate by using the output value and the multiple items of the air cleaner shape information 25a and 25b so as to reduce the pulsation error Err in the air flow rate caused by the uneven flow. For example, as in the fourth embodiment, the pulsation error correction unit 22e uses the multiple items of the air cleaner shape information 25a and 25b to acquire the correction amounts Q correlated with the multiple items of the air cleaner shape information 25a and 25b with reference to the map or using the correction function. Subsequently, the pulsation error correction unit 22e corrects the air flow rate by using the acquired correction amount Q and the output value. That is, the pulsation error correction unit 22e corrects the air flow rate by using the air cleaner shape information as the uneven flow information. Therefore, the pulsation error correction unit 22e corrects the air flow rate by using the air cleaner shape information instead of the uneven flow information in the fourth embodiment and the modification of the fourth embodiment.

In this way, the AFM of the fifth embodiment enables to exhibit a similar effect to that of the AFM of the fourth embodiment. Furthermore, the AFM of the fifth embodiment enables to quantify the uneven flow state caused by the shape of the air cleaner 300.

### Sixth Embodiment

An AFM according to a sixth embodiment (hereinafter referred to simply as AFM) will be described with reference to FIG. 14. In the present embodiment, descriptions of configurations similar to those of the fourth embodiment will be omitted, and configurations different from those of the fourth embodiment will be mainly described. That is, the same configurations as those of the fourth embodiment in the present modification can be understood with reference to the description of the fourth embodiment.

The AFM differs from the AFM of the fourth embodiment in the configuration of a processing unit 20f. As shown in FIG. 14, the processing unit 20f is different from the processing unit 20d in that the processing unit 20f includes a pulsation error correction unit 22f that corrects the air flow rate using multiple uneven flow degrees 26a and 26b and multiple uneven flow degrees 26a and 26b. In other words, the processing unit 20f includes multiple items of the uneven flow degrees 26a and 26b. The present embodiment also employs an example in which the sensing unit 10 is located in the air cleaner 300. In the present embodiment, as an example, the processing unit 20f using two items including the first uneven flow degree 26a and the second uneven flow degree 26b is employed. It is noted that, the processing unit 20f may include three or more items of the uneven flow degree.

The pulsation error correction unit 22f corrects the air flow rate by using the output value and the multiple uneven flow degrees 26a and 26b so as to reduce the pulsation error Err in the air flow rate caused by the uneven flow. For example, as in the fourth embodiment, the pulsation error correction unit 22f obtains the correction amount Q correlated with the multiple uneven flow degrees 26a and 26b with reference to the map or using the correction function by using the multiple uneven flow degrees 26a and 26b. Subsequently, the pulsation error correction unit 22f corrects the air flow rate by using the acquired correction amount Q and the output value. That is, the pulsation error correction unit 22f corrects the air flow rate using the uneven flow degree as the uneven flow information. Therefore, the pulsation error correction unit 22f corrects the air flow rate by using the uneven flow degree instead of the uneven flow information in the fourth embodiment and the modification of the fourth embodiment.

In this way, the AFM of the sixth embodiment enables to exhibit a similar effect to that of the AFM of the fourth embodiment. Furthermore, the AFM of the sixth embodiment enables to quantify the uneven flow state caused by the shape of the air cleaner 300.

### Seventh Embodiment

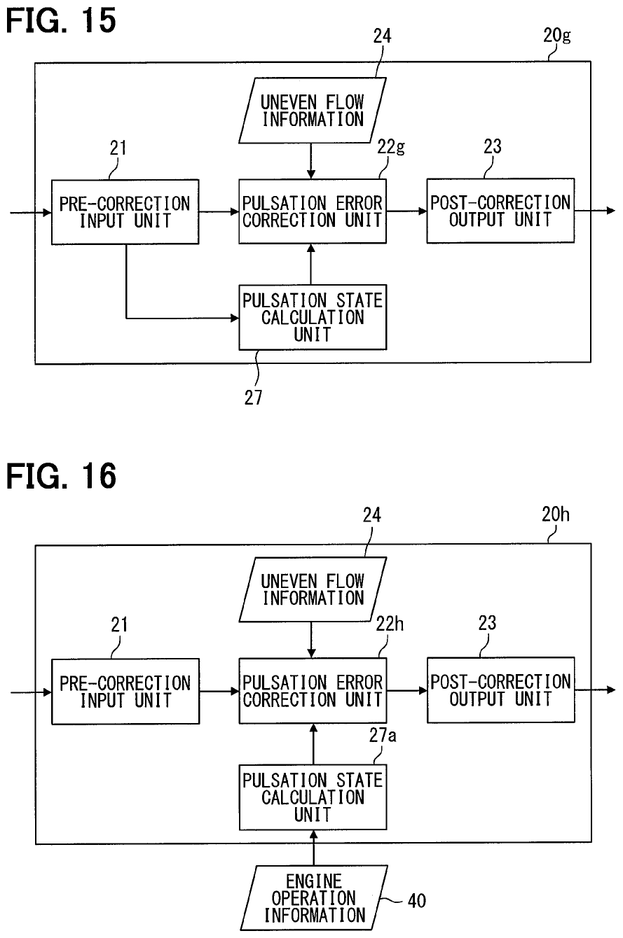

An AFM according to a seventh embodiment (hereinafter referred to simply as AFM) will be described with reference to FIG. 15. In the present embodiment, descriptions of configurations similar to those of the first embodiment will be omitted, and configurations different from those of the first embodiment will be mainly described. That is, the same configurations as those of the first embodiment in the present embodiment can be understood with reference to the description of the first embodiment.

The AFM differs from the AFM 100 in the configuration of a processing unit 20g. As shown in FIG. 15, the processing unit 20g is different from the processing unit 20a in that the processing unit 20g includes a pulsation state calculation unit 27 and a pulsation error correction unit 22g that corrects the air flow rate by using the pulsation state information in addition to the uneven flow information 24. That is, the pulsation error Err caused by the uneven flow also varies depending on the pulsation state of the air flow rate. Therefore, the AFM corrects the air flow rate further by using the pulsation state information.

The pulsation state calculation unit 27 corresponds to a state acquisition unit. The pulsation state calculation unit 27 acquires the pulsation state information by calculating the pulsation state information indicating the state of pulsation of the air flow rate. The pulsation state calculation unit 27 acquires the pulsation state information based on the output value of the pre-correction input unit 21. The pulsation state calculation unit 27 calculates the pulsation state information from, for example, sampling data of at least one cycle of a pulsation waveform of air in an output value. In other words, the pulsation state information indicates the pulsation state of air that affects the pulsation error Err in the environment in which the sensing unit 10 is installed.

The pulsation error correction unit 22g corrects the air flow rate by using the pulsation state information acquired from the pulsation state calculation unit 27 in addition to the output value and the uneven flow information 24 so that the pulsation error Err of the air flow rate caused by the uneven flow becomes smaller. For example, the pulsation error correction unit 22g acquires the correction amount Q correlated with the uneven flow information 24 and the pulsation state information with reference to the map or using the correction function by using the uneven flow information 24 and the pulsation state information. Subsequently, the pulsation error correction unit 22g corrects the air flow rate by using the acquired correction amount Q and the output value.

The pulsation error correction unit 22g acquires the correction amount Q correlated with the uneven flow information 24 and the pulsation state information by using, for example, a map in which the correction amount Q is associated with the uneven flow information 24 and the pulsation state information. In this case, the AFM is provided with a two-dimensional map in which multiple combinations of the uneven flow information 24 and the pulsation state information are associated with the correction amounts Q correlated to the combinations respectively. In this two-dimensional map, for example, the uneven flow information 24 is taken on one axis, the pulsation state information is taken on the other axis, and the correction amounts Q are associated with combinations of the uneven flow information 24 and the pulsation state information, respectively. In other words, the multiple correction amounts Q are values obtained for combinations of the uneven flow information 24 and the pulsation state information, respectively, by implementing an experiment or a simulation using an actual equipment while changing the values of the uneven flow information 24 and the pulsation state information.

In this way, the AFM of the seventh embodiment enables to exhibit a similar effect to that of the AFM 100. Furthermore, the AFM of the seventh embodiment corrects the air flow rate by using the uneven flow information 24 and the pulsation state information, thereby to enable to further enhance the correction accuracy of the air flow rate. The AFM of the seventh embodiment therefore enables to further reduce the pulsation error Err in the air flow rate. In other words, the AFM of the seventh embodiment enables to correct both the pulsation characteristic of the AFM itself and the pulsation characteristic caused by the uneven flow.

In the present embodiment, the air cleaner shape information 25 may be employed as the uneven flow information 24 as in the second embodiment, and this configuration enables to exhibit an effect similar to that of the second embodiment. Further, in the present embodiment, the uneven flow degree 26 may be employed as the uneven flow information 24 as in the third embodiment, and this configuration enables to exhibit an effect similar to that of the third embodiment. The same applies to the eighth embodiment described below.

### Modification 1 of Seventh Embodiment

An AFM according to the seventh embodiment (hereinafter referred to simply as AFM) will be described. In the present embodiment, descriptions of configurations similar to those of the seventh embodiment will be omitted, and configurations different from those of the seventh embodiment will be mainly described. That is, the same configurations as those of the seventh embodiment in the present modification can be understood with reference to the description of the seventh embodiment. The same reference numerals as those in the seventh embodiment are used for the sake of convenience.

The processing unit 20g of this modification is different from that of the seventh embodiment in that a standard deviation σ is used as the pulsation state information. That is, this modification differs from the seventh embodiment in that the processing unit 20g includes the pulsation state calculation unit 27 that calculates the standard deviation σ and the pulsation error correction unit 22g that corrects the air flow rate by using the standard deviation σ in addition to the uneven flow information 24.

The waveform of the air flow rate may have different waveforms even in a case where the maximum value, the minimum value, and the average value of the output flow rate in the sensing unit 10 are the same. Since the pulsation error Err is also different in such different waveforms, there is a need to change the correction amount Q. Therefore, the processing unit 20g corrects the air flow rate by using the standard deviation σ as the pulsation state information.

The pulsation state calculation unit 27 calculates the standard deviation σ from sampling data (multiple sampling values) of at least one cycle of air pulsation in the output value. That is, the pulsation state calculation unit 27 calculates (acquires) the standard deviation σ of the air flow rate by using the multiple sampling values obtained by sampling the A/D converted output value and the Equations 1 and 2.

$$\begin{matrix}σ = \sqrt{{σ}^{2}} & ( Equation 1 ) \\ {σ}^{2} = \frac{1}{n} {\sum }_{i = 1}^{n} {( {x}_{i} - xave )}^{2} & ( Equation 2 )\end{matrix}$$

xᵢ: sampling value, xᵢ to xₙ: population, n: number of samplings (number of data), xave: average value of population

Subsequently, the pulsation error correction unit 22g acquires the correction amount Q correlated with the uneven flow information 24 and the standard deviation σ with reference to the map or using the correction function by using the uneven flow information 24 and the standard deviation σ. The pulsation error correction unit 22g corrects the air flow rate by using the acquired correction amount Q and the output value.

The modification 1 enables to exhibit an effect similar to that of the seventh embodiment. Furthermore, the standard deviation σ enables to differentiate the waveforms by using information thereon at all sampling points. In other words, the standard deviation σ is a parameter that enables to indicate the difference in the waveforms in a case where the waveforms are different from each other even when the maximum value, the minimum value, and the average value are the same. Therefore, the processing unit 20g enables to implement an optimal error correction by acquiring the correction amount Q by using the standard deviation σ. Further in other words, the processing unit 20g calculates the standard deviation σ with the standard deviation calculation unit in order to grasp the pulsation waveform by a statistical amount and to implement the pulsation correction with high accuracy.

### Modification 2 of Seventh Embodiment

An AFM according to the seventh embodiment (hereinafter referred to simply as AFM) will be described. In the present embodiment, descriptions of configurations similar to those of the seventh embodiment will be omitted, and configurations different from those of the seventh embodiment will be mainly described. That is, the same configurations as those of the seventh embodiment in the present modification can be understood with reference to the description of the seventh embodiment. The same reference numerals as those in the seventh embodiment are used for the sake of convenience.

The processing unit 20g of this modification is different from that of the seventh embodiment in that a pulsation rate P is used as the pulsation state information. That is, this modification differs from the seventh embodiment in that the processing unit 20g includes the pulsation state calculation unit 27 that calculates the pulsation rate P and the pulsation error correction unit 22g that corrects the air flow rate by using the pulsation rate P in addition to the uneven flow information 24.

The pulsation error Err varies depending on a pulsation amplitude A and the pulsation rate P. Therefore, the processing unit 20g corrects the air flow rate by using the pulsation rate P as the pulsation state information.

Herein, an example of a method to calculate the pulsation rate P by using the pulsation state calculation unit 27 will be described. The pulsation state calculation unit 27 calculates a maximum value of the air flow rate from the sampling data (multiple sampling values) of at least one cycle of air pulsation in the output value. That is, the pulsation state calculation unit 27 acquires the maximum value of the air flow rate in the measurement period, that is, a pulsation maximum value G max, which is the maximum flow rate, from the output value of the sensing unit 10. In the following description, the minimum value of the air flow rate in the measurement period is also referred to as a pulsation minimum value.

Further, the pulsation state calculation unit 27 calculates an average value of the air flow rate from the sampling data. That is, the pulsation state calculation unit 27 calculates the average flow rate G of the air flow rate in the measurement period from the output value of the sensing unit 10. The pulsation state calculation unit 27 calculates the average flow rate G by using, for example, an integrated average. For example, the time period from a time T1 to a time Tn is a measurement period, the air flow rate at the time T1 is G1, and the air flow rate at the time Tn is Gn. The pulsation state calculation unit 27 calculates the average flow rate G by using Expression 3. In this case, as compared with a case in which the number of samples is small, when the number of samplings is large, the average air amount calculation unit 37 enables to calculate the average air flow rate G with less effect of pulsation minimum values with relatively low detection accuracy.

$$average flow rate G = \frac{{\sum }_{1}^{n} G ( t )}{n} \qquad ( Equation 3 )$$

Furthermore, the pulsation state calculation unit 27 may calculate the average air flow rate G without using the pulsation minimum value, which has the detection accuracy lower than that of the maximum value of the air flow rate, or without using several items of the air flow rate before and after the pulsation minimum value and the pulsation minimum value. The processing unit 20a calculates the pulsation amplitude A and the pulsation rate P from the average flow rate G and the pulsation maximum value G max. The processing unit 20g enables to calculate the pulsation amplitude A and the pulsation rate P with less influence of the pulsation minimum value in the case where the pulsation state calculation unit 27 calculates the average flow rate G without using the pulsation minimum value. In other words, the processing unit 20g calculates the pulsation amplitude A and the pulsation rate P by using the average flow rate G and the pulsation maximum value G max with relatively high detection accuracy, without using the pulsation minimum value with low detection accuracy, when calculating the pulsation amplitude A. Thus, this configuration enables to enhance the calculation accuracy of the pulsation amplitude A and the pulsation rate P.

The pulsation state calculation unit 27 calculates (acquires) the pulsation amplitude A of the air flow rate by taking the difference between the pulsation maximum value G max and the average flow rate G. That is, the pulsation state calculation unit 27 obtains not the full amplitude of the air flow but the half amplitude of the airflow. This is to reduce the influence of the pulsation minimum value with relatively low detection accuracy, as described above. Subsequently, the pulsation state calculation unit 27 divides the pulsation amplitude A by the average flow rate Gave to calculate the pulsation rate P of the air flow rate. The pulsation rate P is a parameter having a correlation with the pulsation amplitude A.

The pulsation error correction unit 22g acquires the correction amount Q correlated with the pulsation rate P. In this case, the pulsation error correction unit 22g acquires the correction amount Q correlated with the pulsation rate P by using, for example, a map in which the pulsation rate P and the correction amount Q are associated with each other. That is, on acquiring the pulsation ratio P with the pulsation state calculation unit 27, the pulsation error correction unit 22g extracts the correction amount Q correlated with the pulsation ratio P as acquired from the map. In this case, the AFM includes a map in which the multiple pulsation rates P and the multiple correction amounts Q correlated with the pulsation rates P respectively are associated. In other words, each correction amount Q is a value acquired for each item of the pulsation rate P by implementing an experiment or a simulation using an actual equipment and while changing the value of the pulsation rate P.

The modification 2 enables to exhibit an effect similar to that of the seventh embodiment. Furthermore, the pulsation state calculation unit 27 calculates the pulsation rate P by using the pulsation rate P acquired without using the pulsation minimum value with low detection accuracy. Therefore, the pulsation state calculation unit 27 enables to acquire the pulsation rate P with less influence of the minimum value of the air flow rate with low detection accuracy.

The pulsation error correction unit 22g acquires the correction amount Q correlated with the pulsation rate P and corrects the air flow rate so that the pulsation error Err becomes smaller. Therefore, the AFM of the modification 2 enables to further enhance the correction accuracy of the air flow rate. That is, the AFM of the modification 2 enables to acquire the air flow rate in which the pulsation error Err is further reduced. In other words, the AFM enables to enhance the robustness in acquiring the parameter for correcting the air flow rate.

The pulsation state calculation unit 27 may calculate the average flow rate G by averaging the pulsation minimum value, which is the minimum value of the air flow rate in the measurement period, and the pulsation maximum value. That is, the pulsation state calculation unit 27 calculates the average flow rate G by using Equation 4.

$$average flow rate G = \frac{\begin{matrix}( pulsation maximum value + \\ pulsation minimum value )\end{matrix}}{2} \qquad ( Equation 4 )$$

### Eighth Embodiment

An AFM according to an eighth embodiment (hereinafter referred to simply as AFM) will be described with reference to FIG. 16. In the present embodiment, descriptions of configurations similar to those of the seventh embodiment will be omitted, and configurations different from those of the seventh embodiment will be mainly described. That is, the same configurations as those of the seventh embodiment in the present modification can be understood with reference to the description of the seventh embodiment.

The AFM differs from the AFM of the seventh embodiment in the configuration of a processing unit 20h. As shown in FIG. 16, the processing unit 20h differs from the processing unit 20g in that the processing unit 20h includes a pulsation state calculation unit 27a that acquires engine operation information 40. The pulsation state calculation unit 27a corresponds to a state acquisition unit.

The pulsation of air is influenced by the operating state of the engine, in other words, the working state of the engine. That is, the pulsation state is correlated to the operating state of the engine. Therefore, the pulsation state calculation unit 27a acquires the pulsation state based on the engine operation information 40 which is a signal from the ECU 200. As described above, the pulsation state calculation unit 27a differs from the pulsation state calculation unit 27 in that the pulsation state calculation unit 27a acquires the pulsation state based on not the output value of the pre-correction input unit 21 but the engine operation information 40 that is a signal from the ECU 200.

The engine operating information 40 indicates the operating state of the engine and may employ an engine rotational speed, a throttle opening degree, a VCT opening degree, and the like. Subsequently, on acquiring the engine operation information 40 from the ECU 200, the pulsation state calculation unit 27a acquires the pulsation state information correlated with the engine operation information 40 with reference to the map, by using the arithmetic expression, or the like. The VCT is a registered trademark.

The pulsation error correction unit 22h corrects the air flow rate by using the pulsation state information acquired from the pulsation state calculation unit 27a in addition to the output value and the uneven flow information 24 so that the pulsation error Err of the air flow rate caused by the uneven flow becomes smaller. The pulsation error correction unit 22h corrects the air flow rate similarly to the pulsation error correction unit 22g.

In this way, the AFM of the eighth embodiment enables to exhibit a similar effect to that of the AFM of the seventh embodiment. Furthermore, the AFM of the eighth embodiment uses the engine operation information 40, and therefore, the processing unit 20h can be reduced in processing load as compared with a configuration using the output value. The AFM of the eighth embodiment may be implemented in combination with the modifications 1 and/or 2 of the seventh embodiment.

### Ninth Embodiment

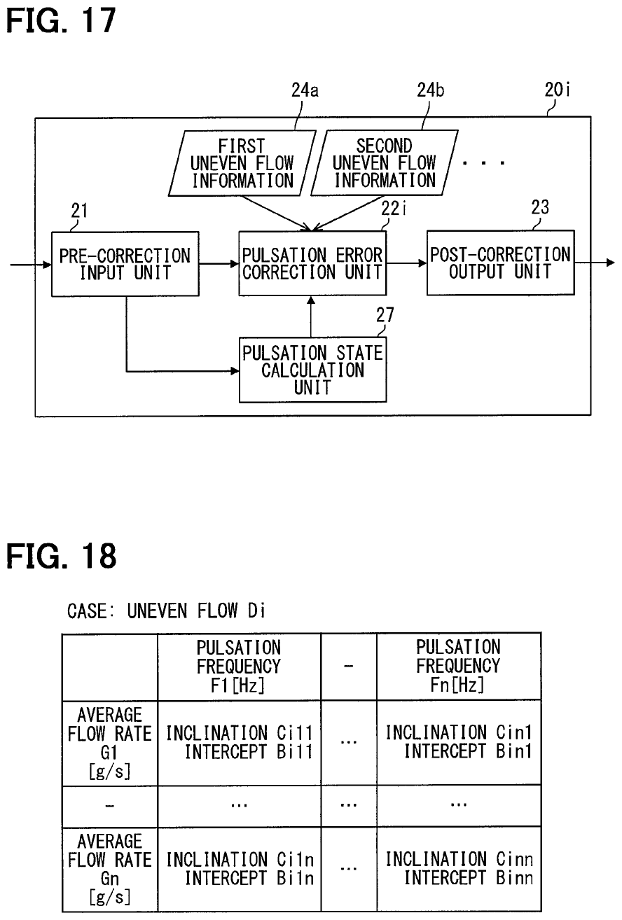

An AFM according to an ninth embodiment (hereinafter referred to simply as AFM) will be described with reference to FIG. 17. In the present embodiment, descriptions of configurations similar to those of the seventh embodiment will be omitted, and configurations different from those of the seventh embodiment will be mainly described. That is, the same configurations as those of the seventh embodiment in the present modification can be understood with reference to the description of the seventh embodiment.

The AFM differs from the AFM of the seventh embodiment in the configuration of a processing unit 20i. As shown in FIG. 17, the processing unit 20i is different from the processing unit 20g in that the processing unit 20i includes a pulsation error correction unit 22i that corrects the air flow rate by using the multiple items of uneven flow information 24a and 24b and the multiple items of uneven flow information 24a and 24b in addition to the pulsation state information. The AFM can be regarded as a combination of the AFM of the fourth embodiment and the AFM of the seventh embodiment.

Herein, an example, in which the correction amount Q is calculated by using a function, is employed. The function can be expressed as a polynomial: correction amount Q=(α1×D1+α2×D2+α3×D3+ . . . )+BG+γF+ηA.

αi, β, γ, η; constant

Di; uneven flow information

G; average flow rate

F; pulsation frequency

A; pulsation amplitude

i; natural number of 1 or more.

Herein, as the pulsation state information, the pulsation amplitude A, which is the amplitude of the pulsation waveform of air in the output value, the pulsation frequency F, which is the frequency of the pulsation waveform, and the average flow rate G, which is the average value of the air flow rate in a predetermined period, are employed. The pulsation error correction unit 22i acquires the pulsation state information based on the output value of the pre-correction input unit 21. The pulsation error correction unit 22i acquires the pulsation state information from, for example, sampling data of at least one cycle of the pulsation waveform of air in the output value.

It is noted that, the present disclosure is not limited to this specific example. The pulsation error correction unit 22i may employ a configuration to use, as the pulsation state information, at least one of the pulsation amplitude A, the pulsation frequency F, and the average flow rate G.

In this way, the AFM of the ninth embodiment enables to exhibit an effect similar to those of the AFM of the fourth embodiment and the AFM of the seventh embodiment. Furthermore, the AFM of the ninth embodiment corrects the air flow rate by using the multiple items of the uneven flow information 24a and 24b and the pulsation state information, thereby to enable to further enhance the correction accuracy of the air flow rate. The AFM of the ninth embodiment therefore enables to further reduce the pulsation error Err in the air flow rate.

In the present embodiment, the air cleaner shape information 25a and 25b may be employed as the uneven flow information 24a and 24b as in the fifth embodiment, and this configuration enables to exhibit an effect similar to that of the fifth embodiment. Further, in the present embodiment, the uneven flow degree 26a and 26b may be employed as the uneven flow information 24a and 24b as in the sixth embodiment, and this configuration enables to exhibit an effect similar to that of the sixth embodiment. This point is the same as in the following tenth embodiment.

The present embodiment may be implemented in combination with the modifications 1 and 2 of the seventh embodiment. That is, in the present embodiment, the standard deviation σ and the pulsation rate P may be further used as one item of the pulsation state information.

### Modification 1 of Ninth Embodiment

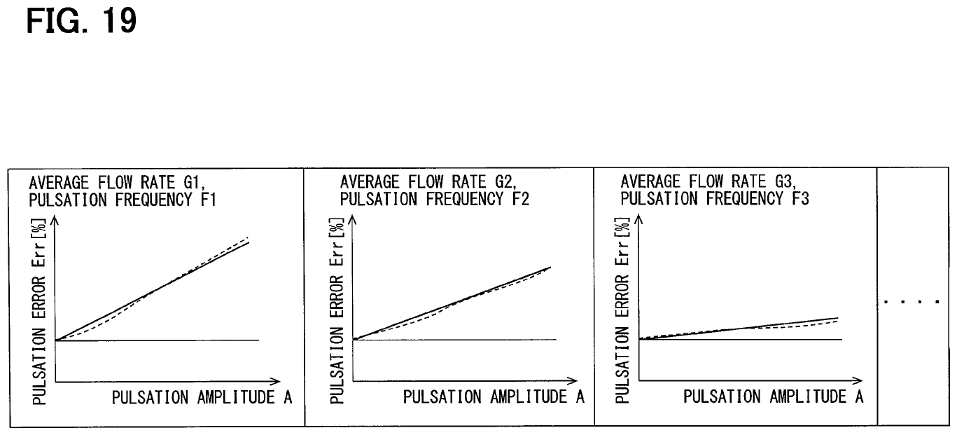

In this example, a modification 1 of the ninth embodiment will be described with reference to FIGS. 18 and 19. The same reference numerals as those in the ninth embodiment are used for the sake of convenience. The pulsation error correction unit 22i of the modification 1 differs from the ninth embodiment in that the pulsation error correction unit 22i determines and corrects the correction amount Q by using a two-dimensional map shown in FIG. 18 and an error prediction equation as follows.

In this case, the pulsation error correction unit 22a acquires the pulsation error Err correlated with the uneven flow information, the pulsation frequency F, the average flow rate G, and the pulsation amplitude A, by using, for example, the two-dimensional map shown in FIG. 18 and the error prediction equation.

pulsation error Err=Cinn×A+Binn Error prediction equation;

Cinn; inclination

Binn; intercept

i; natural number of 1 or more

The relationship between the pulsation error Err (%) and the pulsation amplitude A is different for each combination of multiple pulsation frequencies F and multiple average flow rates G, as shown in FIG. 19. A solid line in FIG. 19 indicates a relationship between the pulsation error Err after correction and the pulsation amplitude A. On the other hand, a dashed line indicates a relationship between the pulsation error Err before correction and the pulsation amplitude A, that is, a pulsation characteristic.

In the map, as shown in FIG. 18, a combination of the inclination Cnn and the intercept Bnn correlated with a combination of the average flow rate G and the pulsation frequency F are associated with each other. Note that FIG. 18 illustrates the two-dimensional map of the uneven flow information Di as an example. The uneven flow information Di corresponds to the uneven flow information 24a and the uneven flow information 24b. For example, the uneven flow information D1 corresponds to the uneven flow information 24a, and the uneven flow information D2 corresponds to the uneven flow information 24b. Further, the inclinations C111, C1n1, C11n, C1nn, and the like are inclinations for the uneven flow information D1. Similarly, the inclinations C211, C2n1, C21n, C2nn, and the like are inclinations for the uneven flow information D2. Therefore, the AFM of Modification 1 includes this sort of two-dimensional map corresponding to each of the multiple items of the uneven flow information Di.

More specifically, in the two-dimensional map, for example, the average flow rates G1 to Gn are taken on one axis, and the pulsation frequencies F1 to Fn are taken on the other axis, and the respective combinations of the average flow rates G1 to Gn and the pulsation frequencies F1 to Fn are associated with the respective combinations of the inclination Cnn and the intercept Bnn. Each of the inclination Cnn and the intercept Bnn may be acquired by implementing an experiment or a simulation by using an actual equipment.

As described above, in other words, the two-dimensional map is used for acquiring the inclination Cnn and the intercept Bnn when calculating the pulsation error Err. In other words, in the map, coefficients in the error prediction equation are associated with the average flow rates G, respectively, and the pulsation frequency F, respectively.

For example, the pulsation error correction unit 22i acquires the inclination C111 and the intercept B111 correspondingly to the uneven flow information D1, the pulsation amplitude A1, the pulsation frequency F1, and the average flow rate G1 by using a two-dimensional map. The relationship between the pulsation amplitude A and the pulsation error Err can be represented by a solid line in the left end graph in FIG. 19. Therefore, the pulsation error correction unit 22i enables to acquire the pulsation error Err by calculating C111×pulsation amplitude A1+B111 by using the error prediction equation.

The pulsation error Err is a difference between the air flow rate, which is obtained from the output value and has not been corrected, and a true value of the air flow rate. That is, the pulsation error Err corresponds to a difference between the air flow rate, which has been converted from the output value by using an output air flow rate conversion table, and the true value of the air flow rate. Therefore, the correction amount Q, which is for bringing the air flow rate before correction closer to the true value of the air flow rate, can be acquired if the pulsation error Err is known. The true value of the air flow rate is an air flow rate which is not affected by the intake pulsation.

The AFM of the present modification configured as described above enables to exhibit an effect similar to that of the AFM of the ninth embodiment.

### Modification 2 of Ninth Embodiment

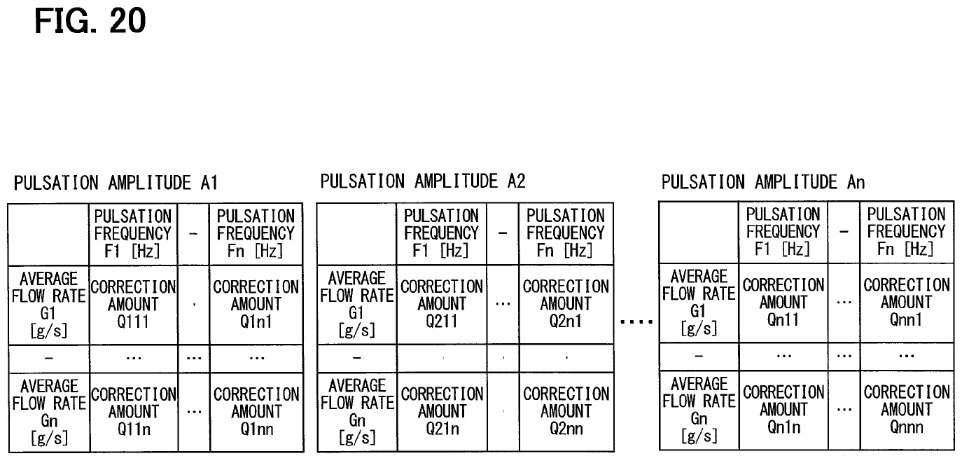

A modification 2 of the ninth embodiment will be described with reference to FIG. 20. The same reference numerals as those in the ninth embodiment are used for the sake of convenience. The pulsation error correction unit 22i of the modification 2 is different from the ninth embodiment in that the pulsation error correction unit 22i acquires the correction amount Q by using a three-dimensional map shown in FIG. 20. The correction amount of the three-dimensional map may be calculated by using a function.

This function can be expressed as a polynomial: correction amount Qijk=α1ijk×D1+α2ijk×D2+α3ijk×D3+ . . . .

αi; constant

Di; uneven flow information

i, j, k; natural number of 1 or more.

As shown in FIG. 20, for example, the pulsation error correction unit 22i acquires the correction information Q correlated with the uneven flow information, the pulsation amplitude A, the average flow rate G, and the pulsation frequency F by using a map, in which the correction amount Q is associated with the pulsation amplitude A, the average flow rate G, and the pulsation frequency F, or the like.

As shown in FIG. 20, the AFM includes a three-dimensional map including two-dimensional maps for pulsation amplitudes A, respectively. In the two-dimensional maps, multiple combinations of the average flow rates G and the pulsation frequencies F are associated with the correction amounts Q correlated to the combinations, respectively. For example, in the two-dimensional map for the pulsation amplitude A1, one axis takes the average flow rates G1 to Gn, and the other axis takes the pulsation frequencies F1 to Fn. In addition, the combinations of the average flow rate G1 to Gn and the pulsation frequency F1 to Fn are associated with the correction amounts Q111 to Q1nn, respectively. The same applies to the two-dimensional map for the pulsation amplitude A2 and the following pulsation amplitude.

On acquiring the pulsation amplitude A, the average flow rate G, and the pulsation frequency F, the pulsation error correction unit 22i acquires the correction amount Q associated with these parameters by using the three-dimensional map. For example, in a case where the pulsation error correction unit 22i acquires the pulsation amplitude A1, the average flow rate G1, and the pulsation frequency F1, the pulsation error correction unit 22i acquires the correction amount Q111.

The AFM of the present modification configured as described above enables to exhibit an effect similar to that of the AFM of the ninth embodiment.

### Tenth Embodiment

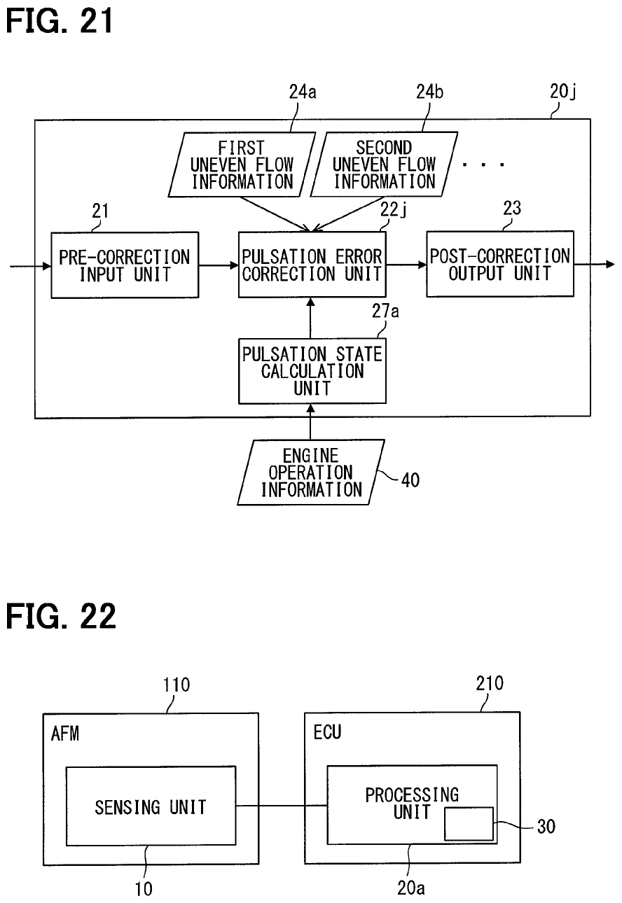

An AFM according to a tenth embodiment (hereinafter referred to simply as AFM) will be described with reference to FIG. 21. In the present embodiment, descriptions of configurations similar to those of the eighth embodiment will be omitted, and configurations different from those of the eighth embodiment will be mainly described. That is, the same configurations as those of the eighth embodiment in the present modification can be understood with reference to the description of the eighth embodiment.

The AFM differs from the AFM of the eighth embodiment in the configuration of a processing unit 20j. As shown in FIG. 21, the processing unit 20j is different from the processing unit 20h in that the processing unit 20j includes a pulsation error correction unit 22j that corrects the air flow rate by using the multiple items of uneven flow information 24a and 24b and the multiple items of uneven flow information 24a and 24b in addition to the pulsation state information. The AFM can be regarded as a combination of the AFM of the fourth embodiment and the AFM of the eighth embodiment.

In this way, the AFM of the tenth embodiment enables to exhibit an effect similar to those of the AFM of the fourth embodiment and the AFM of the eighth embodiment. Furthermore, the AFM of the tenth embodiment corrects the air flow rate by using the multiple items of the uneven flow information 24a and 24b and the pulsation state information, thereby to enable to further enhance the correction accuracy of the air flow rate. The AFM of the tenth embodiment therefore enables to further reduce the pulsation error Err in the air flow rate.

### Eleventh Embodiment

A modification of an eleventh embodiment will be described with reference to FIG. 22. The eleventh embodiment is different from the first embodiment in that the sensing unit 10 is provided to an AFM 110 and the processing unit 20a is provided to an ECU 210. In other words, in the present embodiment, the present disclosure is applied to the processing unit 20a provided in the ECU 210. The present disclosure (air flow rate measuring device) may include the sensing unit 10 in addition to the processing unit 20a.

In the present configuration, the AFM 110 and the ECU 210 enable to exhibit an effect similar to that of the AFM 100. In addition, the AFM 110 does not include the processing unit 20a. Therefore, the processing load of the AFM 110 can be reduced more than that of the AFM 100.

The eleventh embodiment may be applied to the second to tenth embodiments. In that instance, the processing unit 20b to 20j in the respective embodiments are provided to the ECU 210. Therefore, the ECU 210 performs the correction by using the pulsation state information, the air cleaner shape information 25, and the like.

Although the present disclosure has been described in accordance with the examples, it is understood that the present disclosure is not limited to such examples or structures. The present disclosure encompasses various modifications and variations within the scope of equivalents. In addition, while the various combinations and configurations, which are preferred, other combinations and configurations, including more, less or only a single element, are also within the spirit and scope of the present disclosure.

1. An air flow measuring device configured to measure an air flow based on an output value of a sensing unit installed in an environment that allows air to flow therethrough, the air flow measuring device comprising:
an acquisition unit configured to acquire the output value;
a storage unit configured to store uneven flow information that indicates an uneven flow state of air in the environment;
a pulsation error correction unit configured to correct an air flow rate by using at least one item of the uneven flow information and the output value so that a pulsation error of the air flow rate caused by the uneven flow becomes smaller; and
a state acquisition unit configured to acquire pulsation state information that indicates a state of pulsation in the air flow rate, wherein
the state acquisition unit is configured
to calculate an average flow rate, which is an average value of the air flow rate in a predetermined period, from the output value
to determine a pulsation maximum value, which is a maximum value of the air flow rate
to calculate a difference between the pulsation maximum value and the average flow rate to calculate a pulsation amplitude of the air flow rate
to divide the pulsation amplitude by the average flow rate to calculate a pulsation rate of the pulsation waveform of the air in the output value and
to acquire the pulsation rate as the pulsation state information, and
the pulsation error correction unit is configured to correct the air flow rate by using the pulsation state information in addition to the uneven flow information and the output value so that the pulsation error of the air flow rate caused by the uneven flow becomes smaller.

2. The air flow measuring device according to claim 1, wherein
the sensing unit is placed in an air cleaner, the air cleaner being provided in an intake passage of an internal combustion engine, and
the storage unit is configured to store, as the uneven flow information, shape information that indicates a shape of the air cleaner.

3. The air flow measuring device according to claim 1, wherein
the sensing unit is placed in an air cleaner, the air cleaner being provided in an intake passage of an internal combustion engine,
the storage unit is configured to store, as the uneven flow information, an uneven flow degree, wherein
the uneven flow degree is calculated with:
a reference air flow rate, as a numerator, which corresponds to a reference output value output in a condition where the sensing unit is installed to a reference pipe that has a predetermined pipe diameter and allows air to flow therethrough; and
an individual air flow rate, as a denominator, which corresponds to the reference output value output in a condition where the sensing unit is installed to the air cleaner.

4. The air flow measuring device according to claim 1, wherein
the pulsation error correction unit is configured to correct the air flow rate by using the output value and a plurality of items of the uneven flow information so that the pulsation error of the air flow caused by the uneven flow becomes smaller.

5. The air flow measuring device according to claim 1, wherein
the state acquisition unit is configured to acquire, as the pulsation state information, at least one of a pulsation amplitude, a pulsation frequency, and an average flow rate,
the pulsation amplitude is an amplitude of the pulsation waveform of the air flow in the output value,
the pulsation frequency is a frequency of the pulsation waveform, and
the average flow rate is an average value of the air flow rate in a predetermined period.

6. The air flow measuring device according to claim 1, wherein
the state acquisition unit is configured to acquire the pulsation state information based on the output value.

7. The air flow measuring device according to claim 1, wherein
the air flow measuring device is configured to acquire a signal that indicates an operating state of an internal combustion engine from an internal combustion engine control device, the internal combustion engine control device configured to control the internal combustion engine by using the air flow rate corrected by the pulsation error correction unit, and
the state acquisition unit is configured to acquire the signal and to acquire the pulsation state information based on the signal.

8. An air flow measuring device comprising:
a storage device configured to store uneven flow information that indicates an uneven flow state of air in an environment in which a sensing unit is installed; and
a processor coupled to the storage device and configured to perform following steps:
to acquire an output value of the sensing unit;
to measure an air flow based on the output value;
to calculate an average flow rate, which is an average value of the air flow rate in a predetermined period, from the output value;
to determine a pulsation maximum value, which is a maximum value of the air flow rate;
to calculate a difference between the pulsation maximum value and the average flow rate to calculate a pulsation amplitude of the air flow rate;
to divide the pulsation amplitude by the average flow rate to calculate a pulsation rate of the pulsation waveform of the air in the output value; and
to correct the air flow rate by using the uneven flow information, the output value, and the a pulsation rate to reduce a pulsation error of the air flow rate caused by the uneven flow.
